(19) United States
(12) Patent Application Publication
(10) Pub. No.: US 2011/0060796 A1
(43) Pub. Date: Mar. 10, 2011

(54) E-MAIL ADDRESS VERIFICATION SYSTEM

(75) Inventors: Travis M. Grigsby, Austin, TX (US); Andrew D. Hately, Austin, TX (US); Frank L. Jania, Chapel Hill, NC (US)

(73) Assignee: International Business Machines Corporation, Armonk, NY (US)

(21) Appl. No.: 12/554,869

(22) Filed: Sep. 4, 2009

(51) Int. Cl. G06F 15/16

(52) U.S. Cl. 709/206

(57) ABSTRACT

A system for verifying a sender's intent to send an e-mail message to a recipient includes a sender computer having memory and a processor, a sender mail server having memory and a processor, wherein the sender mail server is connected to the sender computer, an e-mail program, wherein the e-mail program is stored in the sender computer's memory, an e-mail message, wherein the e-mail message is stored in the sender computer's memory, an e-mail address verification program, wherein the e-mail address verification program is stored in the sender computer's memory, and a sender correspondence database, wherein the sender correspondence database is stored in the sender computer's memory. A method for verifying a sender's intent to send an e-mail message to a recipient is also disclosed.

### BACKGROUND

The present invention relates to an e-mail address verification system. E-mail is a popular method for disseminating information, even when that information is confidential communications to a company's senior executives. However, because of similarities between e-mail addresses, e-mails are frequently sent to the wrong people. At best, this can cause inconvenience and inefficiency for both the recipient and the sender. Unfortunately, in some cases, the delivery of sensitive information to the wrong people can have serious consequences.

### SUMMARY

One embodiment of the present invention is a method for verifying a sender's intent to send an e-mail message to a recipient. Embodiments of the invention may also include the steps of obtaining a list of e-mail addresses in an e-mail message, obtaining a list of the sender's previous correspondents, and responsive to find a match for an e-mail address in the list of e-mail addresses in the e-mail message in the list of the sender's previous correspondents, sending the e-mail message to the matched e-mail address.

Another embodiment of the present invention is a method for verifying a sender's intent to send an e-mail message to a recipient. Embodiments of the invention may also include the steps of obtaining a list of e-mail addresses in an e-mail message, obtaining the sender's warning list, responsive to finding a match for an e-mail address in the list of e-mail addresses in the e-mail message in the sender's warning list, asking the sender to confirm the matched e-mail address is correct, and responsive to the sender confirming the matched e-mail address is correct, sending the e-mail message to the confirmed e-mail address.

According to one embodiment of the present invention, a system for verifying a sender's intent to send an e-mail message to a recipient includes a sender computer having memory and a processor, a sender mail server having memory and a processor, wherein the sender mail server is connected to the sender computer, an e-mail program, wherein the e-mail program is stored in the sender computer's memory, an e-mail message, wherein the e-mail message is stored in the sender computer's memory, an e-mail address verification program, wherein the e-mail address verification program is stored in the sender computer's memory, and a sender correspondence database, wherein the sender correspondence database is stored in the sender computer's memory.

### BRIEF DESCRIPTION OF THE SEVERAL VIEWS OF THE DRAWINGS

FIG. 1 is a schematic view of an embodiment of the system for verifying a sender's intent to send e-mail to a recipient constructed in accordance with the principles of the present embodiment of the invention.

FIG. 2 is a schematic view of an embodiment of the sender computer of the present embodiment of the invention;

FIG. 3 is a schematic view of an e-mail message.

FIG. 4 is a schematic view of the sender correspondence database of the present embodiment of the invention.

FIG. 5 is a flow diagram view of an embodiment of the e-mail address verification program of the present embodiment of the invention;

FIG. 6 is a flow diagram view of an alternative embodiment of the e-mail address verification program of the present embodiment of the invention;

### DETAILED DESCRIPTION

As will be appreciated by one skilled in the art, the present invention may be embodied as a system, method, or computer program product. Accordingly, embodiments of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments of the invention may take the form of a computer program product embodied in any tangible medium of expression having computer usable program code embodied in the medium.

Any combination of one or more computer usable or computer readable mediums may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium may even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc. The medium may be remote to the user, thus allowing the use of the program over a large area computer network, including a global network such as the Internet.

Computer program code for carrying out operations of embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), whether via wireless, wireline or other transmission means.

An embodiment of the present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

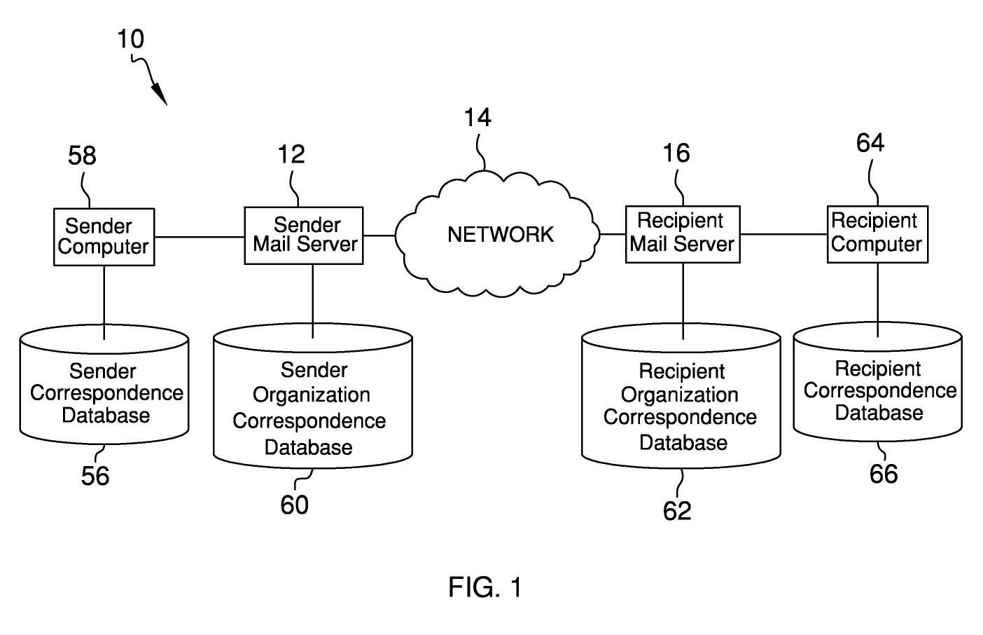

Referring now to FIG. 1, an embodiment of the system for verifying a sender's intent to send e-mail to a recipient 10 is illustrated. More particularly, the embodiment of the system for verifying a sender's intent to send e-mail to a recipient 10 has a sender mail server 12 that is connected by a network 14 to a recipient mail server 16. The network 14 may be any type of computer network, including the Internet. Although only one of each is depicted, one or more sender computers 58 may be connected to the sender mail server 12, and one or more recipient computer 64 may be connected to the recipient mail server 16. In some cases, the senders and recipients may share a single mail server. Each sender computer 58 stores a sender

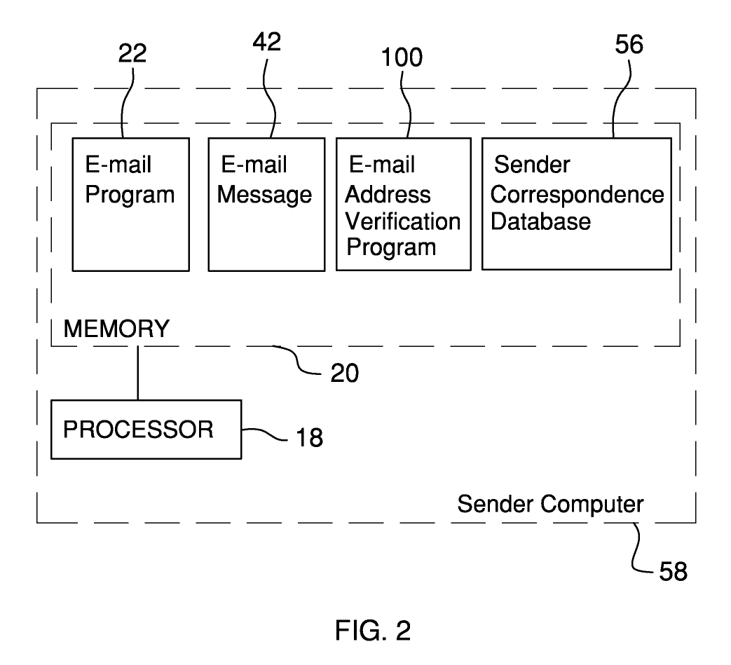

Referring now to FIG. 2, an embodiment of the sender computer 58 is illustrated. More particularly, the sender computer 58 has a processor 18 operably connected to memory 20. The sender mail server 12, recipient mail server 16, and recipient computer 64 have the same architecture. Memory 20 stores an e-mail program 22, an e-mail address verification program 100, an e-mail message 42, and the sender correspondence database 56. Alternatively, the e-mail address verification program 100 may reside on the sender mail server 12. The recipient computer 64 or the recipient mail server 16 may also have a copy of the address verification program 100.

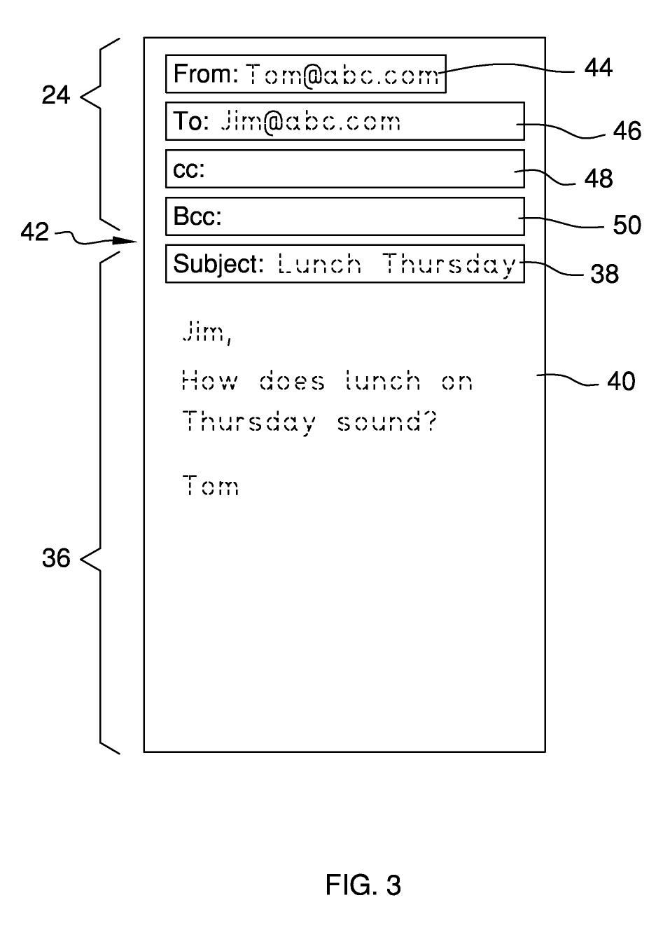

Referring now to FIG. 3, an embodiment of the e-mail message 42 is illustrated. More particularly, the e-mail message 42 has a list of e-mail addresses 24 and content of the e-mail message 36. The list of e-mail addresses 24 includes at least the sender's e-mail address 44 in the From: field and the recipient's address 46 in the To: field. The list of e-mail addresses in an e-mail message 24 may also include carbon copy address 48 and the blind carbon copy address 50 from the CC: and BCC: fields, respectively if the sender has elected for addresses in those fields to be included in the list of e-mail addresses 24. The e-mail message's content 36 includes its body text 40 and its Subject: field 38. The Subject: field 38 typically contains a brief and descriptive phrase of the e-mail message's 42 body text 40.

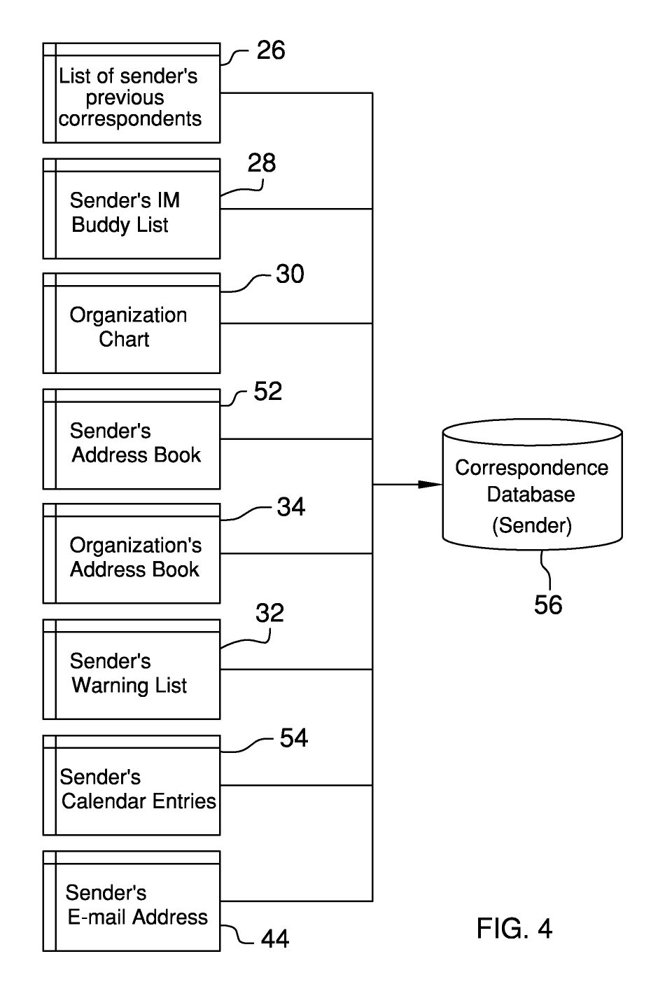

Referring now to FIG. 4, an embodiment of the sender correspondence database 56 is illustrated. More particularly, the sender correspondence database 56 may contain a list of the e-mail message sender's previous correspondents 26, the e-mail message sender's instant messaging buddy list 28, the e-mail message sender's organization chart 30, the e-mail message sender's warning list 32, the e-mail message sender's address book 52, the e-mail message sender's organization's address book 34, the e-mail message sender's calendar entries 54, and the e-mail message sender's e-mail address 44. The list of the e-mail message sender's previous correspondents 26 contains all the e-mail addresses that the sender has sent an e-mail message to in the past or from whom the sender has received an e-mail. The list of the e-mail message sender's previous correspondents may also include how frequently the sender corresponds with each e-mail address, when the last correspondence with each e-mail address occurred, and the subjects of the e-mail messages previously exchanged with each e-mail address. The e-mail message sender's instant messaging buddy list 28 is a list of persons and their associated e-mail addresses whose online status is monitored by the sender's instant messaging software. The e-mail message sender's organization chart 30 is a record of the hierarchical interrelationships of positions within an organization based on their relationship to the sender. The e-mail message sender's warning list 32 is a list of e-mail addresses for which the sender wants to always receive a warning if he or she sends an e-mail address to one of those e-mail addresses prior to the e-mail message being sent. The e-mail message sender's organization's address book 34 is a list of all of the e-mail addresses associated with the e-mail message sender's organization. The e-mail message sender's address book 52 is a list of all of the e-mail addresses the sender wishes to retain. The e-mail message sender's e-mail address 44 is uniquely associated with the sender and, if applicable, may be used as a key field in the sender organization correspondence database 60. When present, the recipient correspondence database 66 stores the identical data for the recipient. The sender organization correspondence database 60 and recipient organization correspondence database 62, when present, replicate and aggregate the data stored in the sender and recipient correspondence databases. Alternatively, the sender and recipient correspondence databases may be used instead of the sender correspondence database 56 and recipient correspondence database 66.

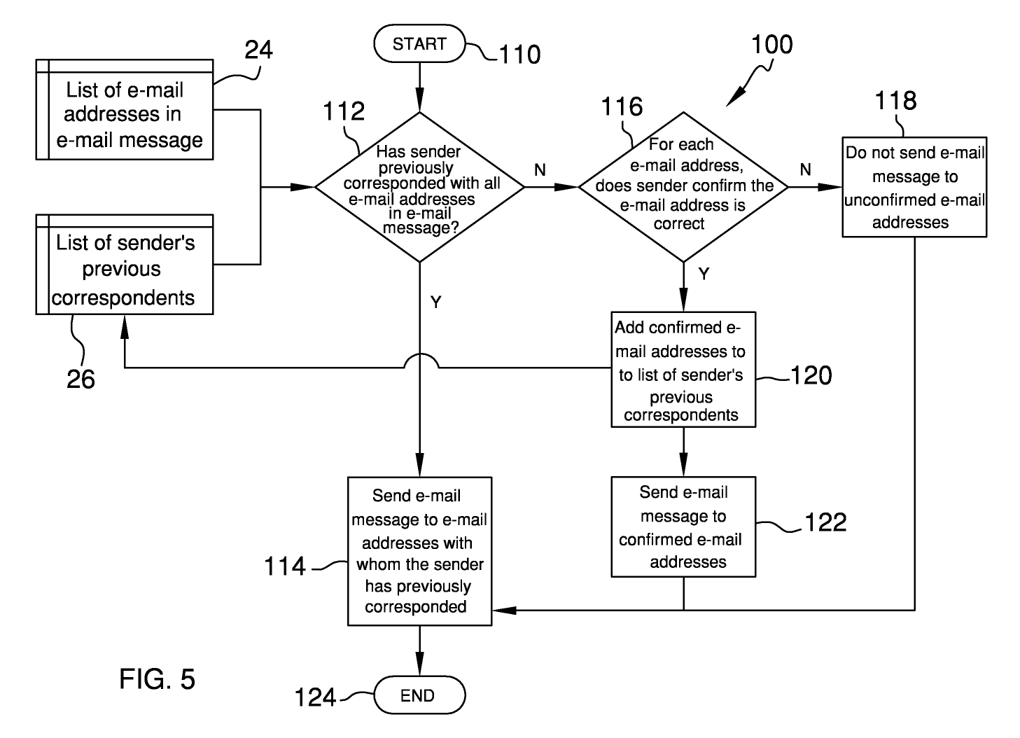

Referring now to FIG. 5, an embodiment of the e-mail address verification program 100 is illustrated. The e-mail address verification flowchart begins (110) with the e-mail address verification program determining if each of the e-mail addresses in an e-mail message the sender has indicated he or she wishes to send appears in a list of e-mail addresses with whom the sender has previously corresponded (112). For those e-mail addresses with which the sender has not previously corresponded, the e-mail address verification program asks the sender to confirm their intent to send the e-mail message to each of those e-mail addresses (116). For those e-mail addresses the sender does not confirm, the e-mail address verification program instructs the e-mail program to not send the e-mail message to those addresses (118). For those e-mail addresses the sender confirms, the e-mail address verification program adds those e-mail addresses to the list of e-mail message sender's previous correspondents (120) and then instructs the e-mail program to send the e-mail message to those addresses (122). Prior to terminating (124), the e-mail address verification program sends the message to all e-mail addresses with whom the sender has previously corresponded (114).

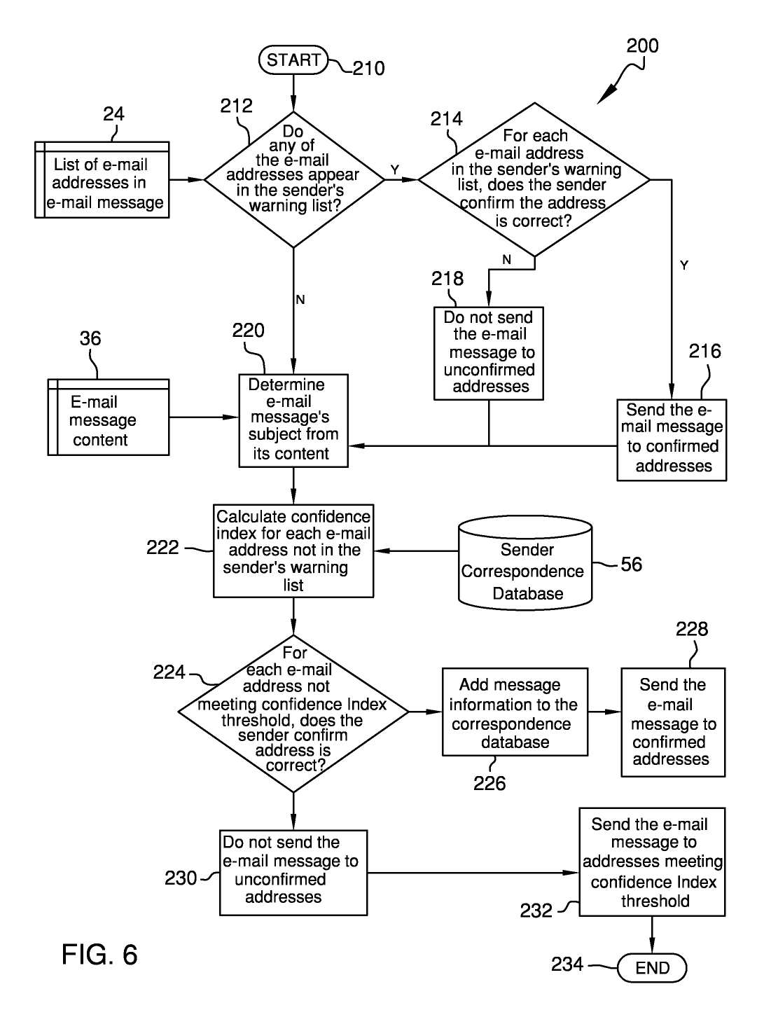

Referring now to FIG. 6, an alternative embodiment of the e-mail address verification program 200 is illustrated. The e-mail address verification flowchart begins (210) with the e-mail address verification program determining if each of the e-mail addresses in an e-mail message the sender has indicated he or she wishes to send appears in the sender's warning list (212). For those e-mail addresses appearing in the sender's warning list, the e-mail address verification program asks the sender to confirm their intent to send the e-mail message to each of those e-mail addresses (214). For those e-mail addresses the sender does not confirm, the e-mail address verification program instructs the e-mail program to not send the e-mail message to those addresses (218). For those e-mail addresses the sender confirms, the e-mail address verification program instructs the e-mail program to send the e-mail message to those e-mail addresses (216). Subsequently, the e-mail address verification program analyzes the e-mail message's content to determine its subject (220). Any suitable method of concept extraction may be used to create tags or classify the e-mail message's subject based upon content parsing to determine its topic. These methods may include word frequency analysis and the proximity of words to other words used in the e-mail message, including the known concept of topic identification disclosed in U.S. Pat. No. 6,104,989. The e-mail address verification program then uses the subject of the e-mail message and data from the sender correspondence database to calculate a confidence index (222). In addition, the e-mail address verification program may maintain sets of valid contacts and associated metadata instead of scanning the sender correspondence database for every e-mail address in the e-mail message. Examples of contact metatags that may be used to include the following: last_e-mail, proximity, proximity_to_others, and workgroup. Any known method of calculating the confidence index may be used, including calculating a weighted sum of tests based on the sender's likelihood of intent to send. This may be expressed as a weighted score based upon parameters such as frequency of communication, the amount of time that has passed since the sender last communicated with the recipient, the proximity of the recipient to the sender in the organization chart, prior discussion of the e-mail message's subject with the recipient, the similarity of the recipient's name or e-mail address to other names or e-mail addresses in the sender's address book or the sender's organization's address book, and the relationship of the recipient to any other recipients of the e-mail message. The relationship of the recipient or any other recipients of the e-mail message may be determined using any suitable method, such as a friend-finding algorithm that computes the probability of other contacts based on a given set of contacts using the sender's organization's address book. A deduction to the confidence index may be applied for e-mail addresses that have been auto completed by the e-mail program. For those e-mail addresses not meeting a confidence index threshold previously established by the sender when configuring the e-mail address verification program, the e-mail address verification program asks the sender to confirm his or her intent to send the e-mail message to each of those e-mail addresses (224). For those e-mail addresses the sender does not confirm, the e-mail address verification program instructs the e-mail program to not send the e-mail message to those addresses (230). For those e-mail addresses the sender confirms, the e-mail address verification program adds message information from the e-mail message to the sender correspondence database (226) and then instructs the e-mail program to send the e-mail message to the confirmed e-mail addresses (228). The message information from the e-mail message that is added to the sender correspondence database may include the list of e-mail addresses in the e-mail message, the e-mail message's subject, and the date and time the e-mail message was written. Prior to terminating (234), the e-mail address verification program instructs e-mail program to send the message to all e-mail addresses meeting the confidence index threshold (232).

When the e-mail address verification program 100 or 200 is installed on the recipient computer 64, it functions in a similar manner to that previously described. In this case, however, the e-mail address verification program 100 asks the recipient to confirm his or her intent to receive an e-mail message from the sender if the sender has not previously corresponded with the recipient or the e-mail message does not meet for a confidence index threshold established by the recipient prior to delivering the received e-mail message to the recipient.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for verifying a sender's intent to send an e-mail message to a recipient comprising:
obtaining a list of e-mail addresses in an e-mail message;
obtaining a list of the sender's previous correspondents; and
responsive to find a match for an e-mail address in the list of e-mail addresses in the e-mail message in the list of the sender's previous correspondents, sending the e-mail message to the matched e-mail address.

2. The method of claim 1, further comprising:
responsive to not finding a match for an e-mail address in the list of e-mail addresses in the e-mail message in the list of the sender's previous correspondents, asking the sender to confirm the unmatched e-mail address is correct; and
responsive to the sender confirming the unmatched e-mail address is correct, sending the e-mail message to the confirmed e-mail address.

3. The method of claim 2, further comprising responsive to the sender confirming the unmatched e-mail address is correct, adding the confirmed e-mail address to the list of the sender's previous correspondents

4. The method of claim 2, further comprising responsive to the sender not confirming the unmatched e-mail address is correct, not sending the e-mail message to the unconfirmed e-mail address.

5. A method for verifying a sender's intent to send an e-mail message to a recipient comprising:
obtaining a list of e-mail addresses in an e-mail message;
obtaining the sender's warning list;
responsive to finding a match for an e-mail address in the list of e-mail addresses in the e-mail message in the sender's warning list, asking the sender to confirm the matched e-mail address is correct; and
responsive to the sender confirming the matched e-mail address is correct, sending the e-mail message to the confirmed e-mail address.

6. The method of claim 5, further comprising responsive to the sender not confirming the matched e-mail address is correct, not sending the e-mail message to the unconfirmed e-mail address.

7. The method of claim 5, further comprising:
obtaining content from the e-mail message;
determining the e-mail message's subject from its content;
responsive to not finding a match for an e-mail address in the list of e-mail addresses in the e-mail message in the sender's warning list, calculating a confidence index for the unmatched e-mail address;
responsive to the unmatched e-mail address having a confidence index not exceeding a threshold, asking the sender to confirm the unmatched e-mail address is correct; and
responsive to the sender confirming the unmatched e-mail address not exceeding the threshold is correct, sending the e-mail message to the confirmed e-mail address.

8. The method of claim 7, further comprising adding the e-mail message's subject and the unmatched e-mail address not exceeding the threshold to the sender's correspondence database.

9. The method of claim 7, further comprising responsive to the sender not confirming the unmatched e-mail address not exceeding the threshold is correct, not sending the e-mail message to the unconfirmed e-mail address not exceeding the threshold.

10. The method of claim 7, further comprising responsive to the unmatched e-mail address having a confidence index exceeding the threshold, sending the e-mail message to the unmatched e-mail address e-mail address exceeding the threshold.

11. A system for verifying a sender's intent to send an e-mail message to a recipient comprising:
a sender computer having memory and a processor;
a sender mail server having memory and a processor, wherein the sender mail server is connected to the sender computer;
an e-mail program, wherein the e-mail program is stored in the sender computer's memory;
an e-mail message, wherein the e-mail message is stored in the sender computer's memory;
an e-mail address verification program, wherein the e-mail address verification program is stored in the sender computer's memory; and
a sender correspondence database, wherein the sender correspondence database is stored in the sender computer's memory.

12. The system of claim 11, further comprising a sender organization correspondence database stored in the sender mail server's memory.

13. The system of claim 11, wherein the sender correspondence database contains at least one of the group comprising a list of the sender's previous correspondents, the sender's instant messaging buddy list, the sender's organization chart, the sender's address book, the sender's organization's address book, the sender's warning list, the sender's calendar entries, and the sender's e-mail address.

14. The system of claim 13, wherein the list of the sender's previous correspondence includes a list of e-mail addresses within the sender has previously corresponded and the subjects of the e-mails exchanged between the sender and his or her correspondents.

15. The system of claim 11, further comprising:
a recipient mail server having memory and a processor, wherein the recipient mail server is connected to the sender mail server;
a recipient computer having memory and a processor, wherein the recipient computer is connected to the recipient mail server;
an e-mail program, wherein the e-mail program is stored in the recipient computer's memory;
an e-mail message, wherein the e-mail message is stored in the recipient computer's memory;
an e-mail address verification program, wherein the e-mail address verification program is stored in the recipient computer's memory; and
a recipient correspondence database, wherein the recipient correspondence database is stored in the recipient computer's memory.

16. The system of claim 11, further comprising a recipient organization correspondence database stored in the recipient mail server's memory.
